(19) United States
(12) Patent Application Publication
(10) Pub. No.: US 2010/0215875 A1
(43) Pub. Date: Aug. 26, 2010

(54) THERMAL TRANSFER-PRINTING FILM AND METHOD UTILIZING THE SAME

(76) Inventors: Ching-Chang YANG, Taipei City (TW); Mao-Feng Hsu, Taipei City (TW); Yu-Chiao Chung, Taipei City (TW)

Correspondence Address: Muncy, Geissler, Olds & Lowe, PLLC, 4000 Legato Road, Suite 310, FAIRFAX, VA, 22033, US

(21) Appl. No.: 12/501,570

(22) Filed: Jul. 13, 2009

(30) Foreign Application Priority Data
Feb. 26, 2009 (TW) 98106112

(51) Int. Cl. B32B 7/04; B32B 37/02

(52) U.S. Cl. 428/32.22; 156/275.5

(57) ABSTRACT

Disclosed are a thermal transfer-printing film and a thermal transfer-printing method utilizing the same. The film has a carrier layer, a post dual-curable protective layer, a decorating layer, and a post dual-curable adhesive layer. The decorating layer includes a post dual-curable printing ink pattern, metal layer such as an embossed surface relief hologram pattern, or combinations thereof. After low temperature thermal transfer on an object surface, the transfer-printing film is then radiation-cured by a free radicals pathway, and optionally simultaneously radiation-cured by a cationic pathway or separately followed by thermal curing.

### CROSS REFERENCE TO RELATED APPLICATIONS

This Application claims priority of Taiwan Patent Application No. 098106112, filed on Feb. 26, 2009, the entirety of which is incorporated by reference herein.

### BACKGROUND OF THE INVENTION

1. Field of the Invention

The present invention relates to a thermal transfer-printing method, and in particular relates to the thermal transfer-printing film thereof.

2. Description of the Related Art

The conventional thermal transfer-printing process, comprises printing a plastic pattern on a carrier layer, thermal transferring the plastic pattern to an object surface, and tearing the carrier layer to complete the thermal transfer-printing process. Due to the simple operating process, inexpensive required machinery, lack of environmental pollution and relatively high operating margins, the conventional thermal transfer-printing process, is the most popularly used today. A pattern, however, without a protective layer is easily scratched. Thus, after the transfer-printing process, a paint is required to be painted onto the pattern for protection. However, adding the paint increases costs and adds pollutants to the operating process. In some thermal transfer-printing films, a release film is attached the carrier layer, and a thermoplastic resin is disposed between the pattern layer and the carrier layer to be served as a protective layer. However, the protective layer composed of thermoplastic resin cannot meet the industry requirements such as abrasion and scratch resistance and hardness. To prevent fusing in transferring process and have better physical properties after transferring process, the resin of the protective layer must have high molecular weight. Because the resin is completely cured and crosslinked, the tensile property of the thermal transfer-printing film is dramatically reduced, thereby hardly being transferred to curved object. In addition, the thermal transfer-printing method adheres the object and the pattern by hot melt adhesive. The typical hot melt adhesives has a processing temperature of 150° C. to 350° C. and a process period of 10 minutes to 30 minutes, such that most of the plastic object will be damaged. The pattern layer of the thermal transfer-printing film is generally prepared by dye/pigment and the thermoplastic resin, such that the pattern layer cannot satisfy the industry requirements. If the resins of the pattern layer, the hot melt adhesive, and the protective layer are incompatible, the pattern will be cloudy and even lose fastness. Accordingly, the thermal transfer-printing method of remaining low pollution, simultaneously enhancing industry requirements such as abrasion/scratch/climate resistance, fastness, and brightness, and reducing process cost/period to increase economic efficiency is called for.

Taiwan new-type patent application serial No. 96208651 provides a transfer-printing film for continuously thermal transfer printing in large area. The transfer-printing film includes a carrier layer having a release layer, a pattern layer, and an adhesive layer, wherein the carrier layer is PET or paper, the pattern layer is pigment ink of high thermal resistance, and the adhesive layer is a reactive hot melt adhesive. Because the adhesive layer thereof is composed of high temperature reactive hot melt adhesive, the inactive hot melt adhesive defects such as softness and poor thermal resistance after transferring can be overcome. Therefore, the product has better properties and higher price. However, the high temperature reactive hot melt adhesive should processed at temperature of 150° C. to 250° C. for 5 minutes to 10 minutes to be effective, and this high temperature process will deform the plastic materials. As such, the thermal transfer-printing film of this patent cannot be applied in plastic object. Next, the resin of the protective layer thereof is a non-reactive resin whatever heated or exposed by an ultraviolet. The protective layer will not hot melt at high temperature of 150° C. to 250° C., such that the pattern layer will not be cloudy. Obviously, the resin of the protective layer has very high molecular weight. Because the carrier layer thereof is PET or paper with low tensile property, it is only thermal transfer-printed on a planar object other than a curved object. In addition, the release agent used to remove the carrier layer is easily remained as residue gel in high temperature process, thereby increasing the post treatment cost. Furthermore, this application points out that the pattern layer is a high thermal resistance ink not only showing a pattern but also crosslinking the protective layer and the adhesive layer. The non-reactive resin of the pattern layers is only hot melted with the protective layer and the adhesive layer on surface, such that the appearance and the properties of the thermal transfer-printing film cannot be improved but degraded due to phase separation.

Because high temperature and lone period process, the plastic object cannot utilize the thermal transfer-printing film with high temperature reactive hot melt adhesives. For solving this problem, U.S. Pat. Nos. 7,236,093, 6,259,962, 6,228,465, 6,025,017, 6,040,040, 5,992,314, and 5,128,388 disclose UV-curing methods to photo cure the hot melt adhesive, thereby efficiently lowering the process temperature and shortening process period. However, the photo curing process thereof should be processed before the step of thermal transferring, such as cured in line of production or printed as small area ribbon or label on the object by a printer. The cured thermal transfer-printing films have macro molecular weight and low tensile property, such that the films cannot be transferred to large area curved object.

The general resins are applied as protective layer in conventional multi-layered transfer-printing films, and the resin cannot prevent the pattern layer from damaging and scrubbing due to its inherence. U.S. Pat. Nos. 6,896,981, 6,887,557, 6,489,015, 6,245,382, and 5,114,783 disclose that the photo curing can be applied to form protective layer of a multi-layered structure, thereby improve its properties and shortening process period. Similar to Taiwan new-type Pat. Application No. 96208651, however, the protective layer is cured before thermal transfer-printing. As such, the cured protective layer loses tensile property and cannot transfer-printed to curved object. Furthermore, the UV cured protective layer of these patents is just served as a multi-layered structure other than a thermal transfer-printing film.

The general resin is usually selected to be a binder in pattern layer ink of general thermal transfer-printing films, and the pattern layer property is limited to resin inherency. U.S. Pat. Nos. 6,179,730 and 6,225,369 disclose that photo curing can be applied to form pattern layer having better property. In U.S. Pat. No. 6,179,730, the photo cured pattern layer is firstly cured and then thermal transfer-printed to golf head. In U.S. Pat. No. 6,225,369, the pattern layer is transferred and then photo cured. The ink of U.S. patents is photo cured to form pattern layer with improved property, and the protective layer is then spray-coated on the pattern layer. As such, the above methods have small transfer-printing area and higher process cost.

Accordingly, a novel thermal transfer-printing film and method thereof is called for.

### BRIEF SUMMARY OF THE INVENTION

The invention provides a thermal transfer-printing film, comprising: a carrier layer; a protective layer overlying the carrier layer; a decorating layer overlying the protective layer; and an adhesive layer overlying the decorating layer, wherein the protective layer and the adhesive layer are a post dual-curable composition comprising an oligomer, a monomer, a resin, and an initiator combination, and wherein the initiator combination is a combination of a radical photo initiator and a cationic photo initiator, or a combination of a radical photo initiator and a radical thermal initiator.

The invention also provides a thermal transfer-printing method, comprising: transferring the thermal transfer-printing film as claimed in claim 1 on an object surface; thermal adhering the adhesive layer to the object surface; and radiation curing the adhesive layer and the protective layer.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a cross section of the thermal transfer-printing film in one embodiment of the invention:

FIGS. 2A-2D are serial views showing the thermal transfer-printing method in one embodiment of the invention; and

FIGS. 3A-3D are serial views showing the thermal transfer-printing method in another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

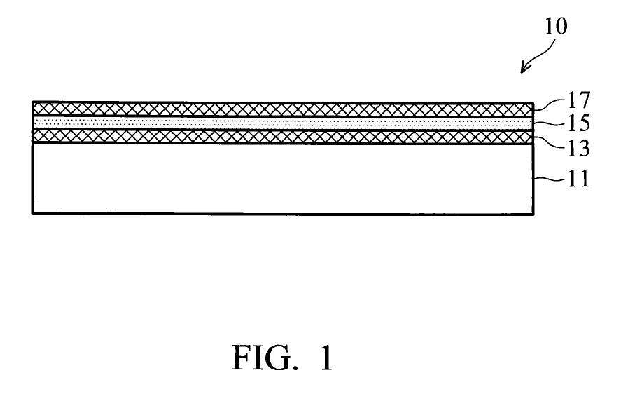

As shown in FIG. 1, the thermal transfer-printing film 10 of the invention having a carrier layer 11, a protective layer 13, a decorating layer 15, and an adhesive layer 17 were subsequently formed on the carrier layer 11. In one embodiment, the carrier layer 11 can be water-based or solvent-based, such as poly(ethylene terephthalate) (PET), polyterephthalate, 1,4-cyclohexylmethylene ester, polyvinylchloride, polyvinyl alcohol (PVA), polyvinylpyrrolidone, acetyl cellulose, polypropylene amide, acetylbutyl cellulose, gelatin, bone flue, sodium alginate, hydroxyl ethyl cellulose, carboxyl methyl cellulose, and the likes. In one embodiment, the carrier layer 10 has a thickness of 15 μm to 150 μm. If the carrier layer is thinner than the above range, it will not be commercially available and may be easily damaged when the thermal transfer-printing film 10 is transferred to the object surface, thereby reducing product quality and yield. On the other hand, if the carrier layer is thicker than the above range, it will reduce the thermal transfer-printing efficiency and increase manufacturing cost.

In the thermal transfer-printing film 10 of the invention, the protective layer 13, the ink of the decorating layer 15, and the adhesive layer 17 are all a post curable composition including radical photo initiator, cationic photo initiator, radical thermal initiator, oligomer, monomer, and resin. The definition of the “post curing” is the curing process performed after the thermal transfer-printing film is transferred to the object, thereby hindering defects for conventional thermal transfer-printing films. The post dual curing mechanisms of the invention include two types. The first dual curing type is a combination of the radical photo initiator and the cationic photo initiator, and, following curing, the former produces free radicals and the later produces acid when exposed to radiation. Note that the acid from the cationic photo initiator will continuously react to cure even if the radiation is absent, such that the acid has a dark curing ability. The first dual curing mechanism simultaneously produces free radicals and acid by a similar radiation, and the thermal transfer-printing film 10, shown under the curved part of the curved object (shadowed part), can be compensatively cured by the cationic photo initiator. The second dual curing type is a combination of the radical photo initiator and the radical thermal initiator, wherein following curing, the former produces free radicals as described before, and the later produces free radicals when applied a thermal source. Note that the free radicals from the radical thermal initiator will react to cure even if the radiation is absent, such that the radical thermal initiator has a dark curing ability. The second dual curing mechanism produces free radicals by radiation and then produces radicals by a thermal source, and the thermal transfer-printing film 10, as shown under the curved part of the curved object (shadowed part), can be compensatively cured by the radical thermal initiator. The protective layer 13, the decorating layer 15, and the adhesive layer 17 of the invention are exposed to a radiation, and the photo initiator or thermal initiator thereof produces radicals or cations to polymerize and cure the oligomers, the monomers, and the resins. If the post dual curing type of curing is used for cationic and radical photo curing, the protective layer 13, the ink of the decorating layer 15, and the adhesive layer 17 can be cured by a single radiation process, such as an ultraviolet light or electron beam process, or combinations thereof. A suitable ultraviolet light has an intensity of 0.0004 to 100 watts/cm², a wavelength of 250 nm to 420 nm, and an exposure period of 1 second to 10 minutes. If the post dual curing type of curing is used for radical photo and thermal curing, the radical photo can be as described above, and the latter thermal curing can be IR, or hot blast oven curing, or combinations thereof. A suitable thermal curing has a temperature of 70° C. to 90° C. for all objects and 70° C. to 150° C. for objects having high thermal resistance. The thermal curing period can be 3 minutes to 30 minutes according to the radical thermal initiator type.

In one embodiment, the protective layer 13 has a thickness of 1 μm to 50 μm. If the protective layer 13 is too thin, it will lose its protection function. If the protective layer 13 is too thick, it will influence the speed of the photo curing of the adhesive layer 17. In one embodiment, the ink of the decorating layer 15 has a thickness of 0.5 μm to 30 μm. If the decorating layer 15 is too thin, it will lose decorating effect. If the decorating layer 15 is too thick, it will influence the photo curing efficiency of the thermal transfer-printing film. In one embodiment, the adhesive layer 17 has a thickness of 1 μm to 15 μm. If the adhesive layer 17 is too thin, it may lose its adhering ability. If the adhesive layer 17 is too thick, it will influence the photo curing efficiency of the thermal transfer-printing film or cannot be completely cured to lose adhering ability.

The protective layer 13 includes 20 wt % to 70 wt % of a resin, 10 wt % to 50 wt % of an oligomer, and 14 wt % to 29.8 wt % of a monomer. If the first type of post dual curing mechanism using a radical photo initiator combined with a cationic photo initiator is selected, the protective layer 13 includes a 0.1 wt % to 3 wt % of a radical photo initiator and 0.1 wt % to 3 wt % of a cationic photo initiator. If the second type of post dual curing mechanism using a radical photo initiator combined with a radical thermal initiator is selected, the protective layer 13 includes a 0.1 wt % to 3 wt % of a radical photo initiator and 0.1 wt % to 3 wt % of a radical thermal initiator.

The adhesive layer 17 includes 20 wt % to 70 wt % of a resin, 10 wt % to 50 wt % of an oligomer, and 14 wt % to 29.8 wt % of a monomer. If the first type of post dual curing mechanism using a radical photo initiator combined with a cationic photo initiator is selected, the adhesive layer 17 includes 0.1 wt % to 3 wt % of a radical photo initiator and 0.1 wt % to 3 wt % of a cationic photo initiator. If the second type of post dual curing mechanism using a radical photo initiator combined with a radical thermal initiator is selected, the adhesive layer 17 includes 0.1 wt % to 3 wt % of a radical photo initiator and 0.1 wt % to 3 wt % of a radical thermal initiator. The resins of the adhesive layer 17 and the protective layer 13 are different. The resin of the adhesive layer 17 can be a hot melt adhesive 780A (EVA, commercially available from Tex Year, Taiwan) resin or 863H1 (polyamide) resin. In addition, the resins of the protective layer 13 and the adhesive layer 17 can be water-based. Collocating a water-based carrier layer 11 does not require solvents and is environment friendly.

The monomer of the protective layer 13 and the adhesive layer 17 is applied as a solvent to dissolve oligomer, and the solution can be coated on the carrier layer 11. Furthermore, the monomer will polymerize with the oligomer after initiating with the initiator, and the solvent residue problem is absent in the invention. The resin, thermoplastic or thermo setting, of the protective layer 13 and the adhesive layer 17 may modify the viscosity of the layers. In one embodiment, the thermoplastic resin includes acrylic resin, polyurethane resin, amino resin, carbamide resin, epoxy resin. polyester resin, vinyl resins such as chlorovinyl resin, ethylene-vinyl acetate resin, polyolefin resin, chloro polyolefin resin, vinyl acrylic resin, petroleum resin, or cellulose derivative resin. The acrylic resin, polyurethane resin, cellulose derivative resin, and ethylene-vinyl acetate resin are more preferable. The thermosetting resin includes at least two reactive functional groups for crosslinking. The functional groups can be N-methylol, N-alkoxymethyl, amino, hydroxyl, isocyanate, carboxyl epoxy, methoxy, carboxyl anhydride, or ethylene. In one embodiment of the invention, the oligomer and the monomer can include the described reactive functional groups such as epoxy acrylic ester, urethane acrylic ester, ester acrylic ester, ether acrylic ester, acrylic-acrylic resin, unsaturated resin, or monomer/oligomer or at least one acrylic ester functional group.

The radiation type, wavelength, and energy intensity are determined by the radical photo initiator. The radical photo initiator includes acetophenones such as 2-methyl-1-(4-(methylthio)phenyl)-2-morpholino-propane), 1-hydroxycyclohexyl phenyl ketone, diethoxyacetophenone, 2-hydroxy-2-nethyl-1-phenyl-propane-1-one, 2-benzyl-2-(dimethylamino)-1-[4-(morpholinyl)phenyl]-1-butanone, or other suitable acetophenones. The radical photo initiator also includes benzoins such benzoin methyl ether, benzyl dimethyl ketal, or other suitable benzoins. The radical photo initiator further includes benzophenones such as 4-phenyl benzophenone, hydroxyl benzohenone, or other suitable benzophenones. The radical photo initiator includes thioxanthones such as isopropyl thioxanthone, 2-chlorothioxanthone, or other suitable thioxanthones. The radical photo initiator also includes anthraquinones such as 2-ethylanthraquinone, or the likes. The described radical photo initiator can be used individually, or collectively to obtain higher photosensitivity. For example, the photo initiator combination can be isopropyl thioxanthone mixed with 2-benzyl-2-(dimethylamino)-1-[4-(morpholinyl)phenyl]-1-butanone.

In addition to the radical initiator, the photo initiator of the invention may further include the cationic photo initiators such as several salts disclosed in U.S. Pat. No. 3,708,296, commodities UVI-6794, UVI-6976, UVI-6970, UVI-6960, or UVI-6990 commercially available from Dow Corp. commodities CD-1010. CD-1011, or CD-1012 commercially available from Sartomer, commodities Adekaoptomer such as SP-150, SP-151, SP-170, SP-171 commercially available from Asahi Denka Kogyo Co. Ltd., commodity Irgacure 261 commercially available from Ciba Specialty Chemicals Corp., commodities CI-2481, CI-2624, CI-2639, or CI-2064 commercially available from Nippon Soda Co. Ltd., or commodities DTS-102, DTS-103, NAT-103, NDS-103, TPS-103, MDS-103, MPI-103, or BBI-103 commercially available from Midori Chemical Co. Ltd. The described cationic photo initiator can be used individually or collectively if necessary.

The radical thermal initiator has a decomposition temperature of about 55° C. to 150° C. The radical thermal initiator can be an azo compound such as 2,2′-azobis(2,4-dimethyl valeronitrile), dimethyl 2,2′-azobis(2-methylpropionate), 2,2-azobisisobutyronitrile (hereinafter AIBN), 2,2-azobis(2-methylisobutyronitrile), 1,1′-azobis(cyclohxane-1-carbonitrile), 2,2′-azobis[N-(2-prophenyl)-2-methylpropionamide], 1-[(cyano-1-methylethyl)azo]formamide, 2,2′-azobis(N-butyl-2-methyl propionamide), 2,2′-azobis(N-cyclohexyl-2-methylpropionamide), or other suitable azo compounds. The radical thermal initiator also includes peroxide such as benzoyl peroxide, 1,1-bis(tert-butylperoxyl)cyclohexane, 2,5-bis(tert-butylperoxy)-2,5-dimethylcyclohexane, 2,5-bis(tert-butylperoxy)-2,5-dimethyl-3-cyclohexyne, bis(1-tert-butylperoxy)-1-methyl-ethyl)benzene, tert-butyl hydroperoxide, tert-butyl peroxide, tert-butyl perperoxybenzoate, cumene hydroperoxide,cyclohexanone peroxide, dicumyl peroxide,lauroyl peroxide, or other suitable peroxides. The described radical thermal initiator can be used individually or collectively if necessary.

The decorating layer 15 can be a printing ink pattern, metal layer such as surface relief hologram, or combinations thereof. The printing ink pattern is printed on the protective layer 13. The ink is post curable solvent-based or water-based, including about 15 wt % to 50 wt % of a resin, 5 wt % to 45 wt % of an oligomer, 9 wt % to 24.8 wt % of a monomer, 5 wt % to 20 wt % of pigment, and 1 wt % to 5 wt % of dispersant, and a dual curable initiator combination. If the first type of post dual curing mechanism using a radical photo initiator combined with a cationic photo initiator is selected, the ink of the decorating layer 15 includes 0.1 wt % to 3 wt % of a radical photo initiator and 0.1 wt % to 3 wt % of a cationic photo initiator. If the second type of post dual curing mechanism using a radical photo initiator combined with a radical thermal initiator is selected, the ink of the decorating layer 15 includes 0.1 wt % to 3 wt % of a radical photo initiator and 0.1 wt % to 3 wt % of a radical thermal initiator. The surface relief hologram can be formed by a printing or evaporating process, composed of metal or metal compound. The metal includes Be, Mg, Ca, Sr, Ba, La, Ce, Cr, Mn, Cu, Ag, Au, Al, Sb, Pd, or Ni. The metal compound includes Sb₂S₃, Fe₂O₃, PbO, ZnSe, CdS, Bi₂O₃, TiO₂, PbCl₂, CeO₂, Ta₂O₅, ZnS, ZnO, CdO, Nd₂O₃, Sb₂O₃, ZrO₂, WO₃, Pr₆O₁₁, SiO, In₂O₃, Y₂O₃, TiO, ThO₂, Si₂O₃, PbF₂, Cd₂O₃, La₂O₃, MgO, Al₂O₃, LaF₃, CeF₃, NdF₃, ThF₄, and the likes. In one embodiment, the decorating layer 15 is post dual curable, such that the stability between the decorating layer 15, protective layer 13, and the adhesive layer 17 is enhanced to prevent a cloudy phenomenon of the pattern.

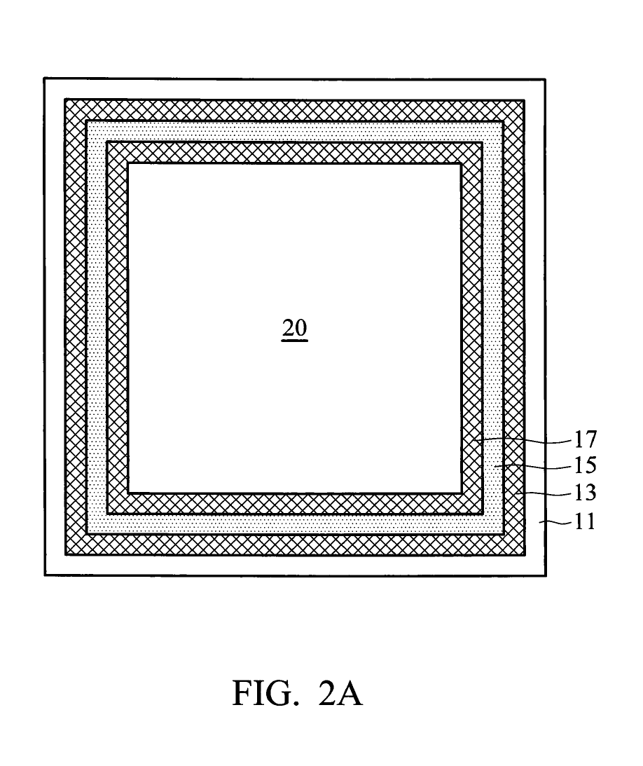

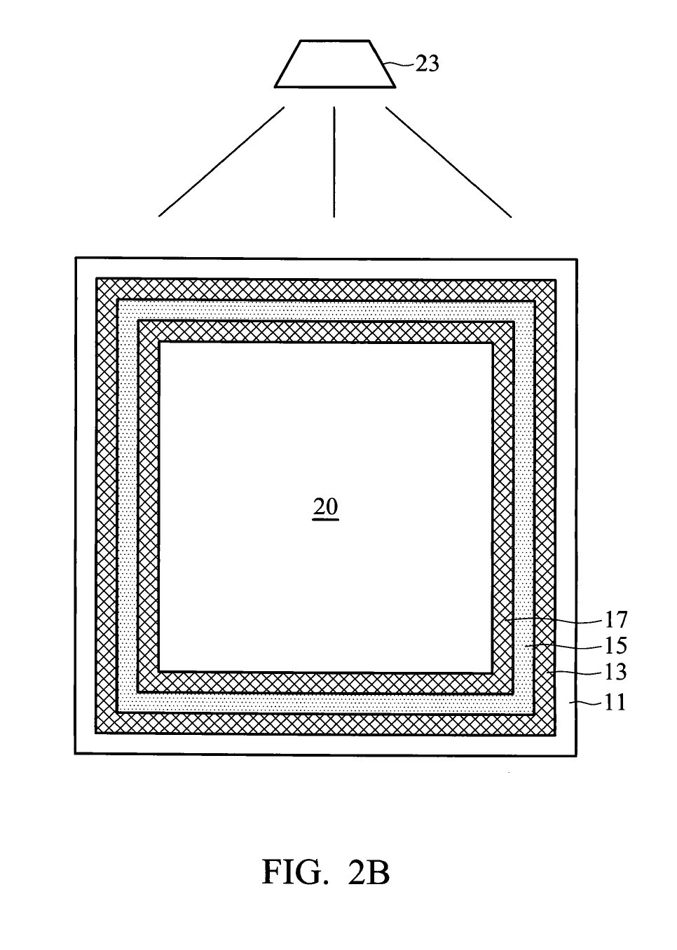

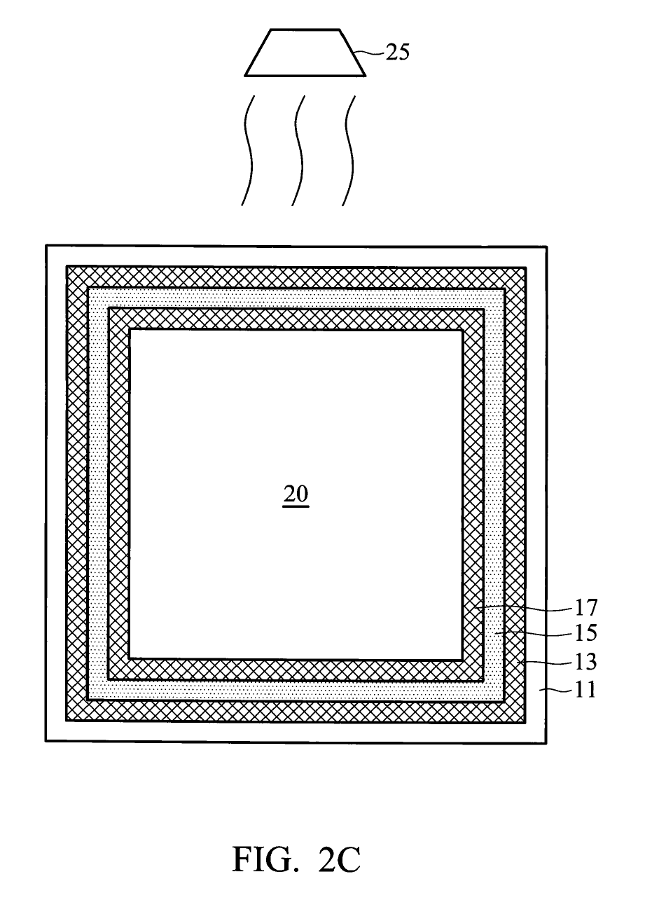

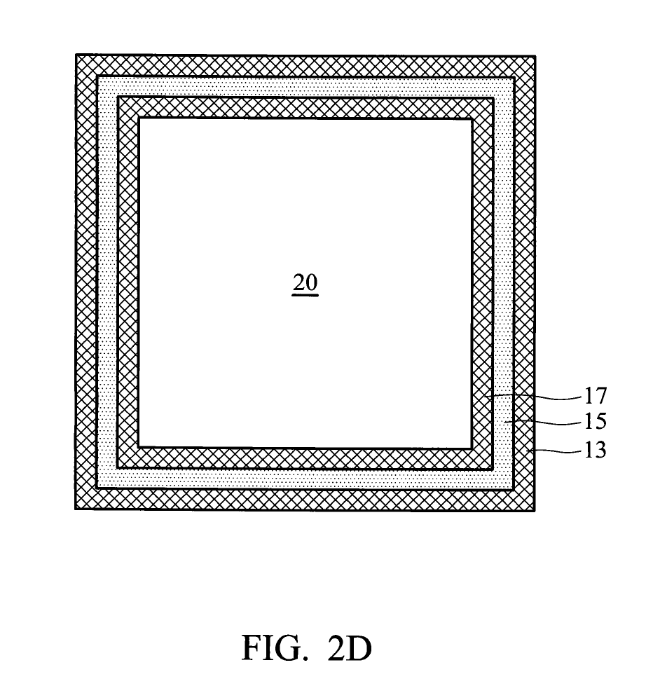

The thermal transfer-printing method utilizing the described thermal transfer-printing film is described below. As shown in FIG. 2A, the thermal transfer-printing film 10 is transferred and adhered to the surface of an object 20. The transferring and adhering step can be a vacuum adhering process with a low temperature soft roller or mold compact to exhaust gas. The thermal adhering step has a temperature of about 50° C. to 150° C. and period of 5 seconds to 2 minutes. Because the temperature and the period thereof is much lower than that of the conventional thermal adhering step, the object 20 of the invention can use high thermal resistance materials such as metal, ceramic, glass, and alloy, and low thermal resistance materials such as wood or glass. Note that the thermal adhering step of the invention is just used to adhere the adhesive layer 17 to the object 20, and the thermal adhering temperature and period cannot initiate the radical thermal initiator of the second post dual curing mechanism. In short, the thermal transferring and adhering step does not cure the protective layer 13 and the adhesive layer 20.

As shown in FIG. 2B, the object 20 and the film are exposed to a radiation to cure the adhesive layer 17, the ink of the decorating layer 15, and the protective layer 13. The suitable radiation can be ultraviolet light, electron beam, or combinations thereof. In one embodiment, the post dual curing mechanism of the protective layer 13, the ink of the decorating layer 15, and the adhesive layer 17 is selected as a combination of a radical photo initiator and cationic photo initiator, wherein an additional curing step is not needed after exposure to the radiation. In another embodiment, the post dual curing mechanism of the protective layer 13, the ink of the decorating layer 15, and the adhesive layer 17 is selected as a combination of a radical photo initiator and radical thermal initiator, wherein an additional thermal curing step is needed to further cure the film after exposure to the radiation as shown in FIG. 2C. The thermal curing step has a temperature of 70° C. to 90° C. and a period of 3 minutes to 30 minutes for completion of the thermal curing.

As shown in FIG. 2D, the carrier layer 11 is torn to complete the product. Note that this removal step does not occur immediately after the post dual curing step. The carrier layer 11 may serve as an additional protective layer, and remain until sold and then removed by consumers themselves. As such, the carrier layer may protect the product from damage when being transported.

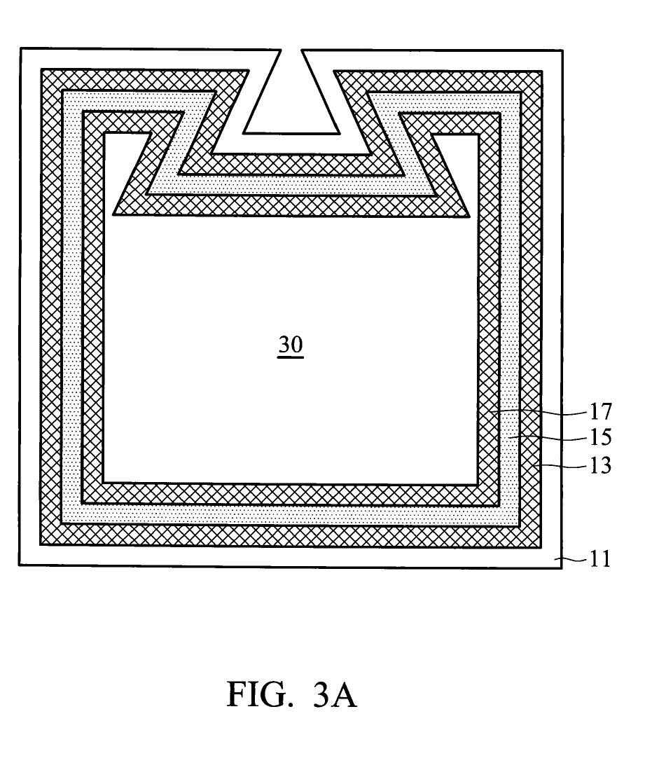

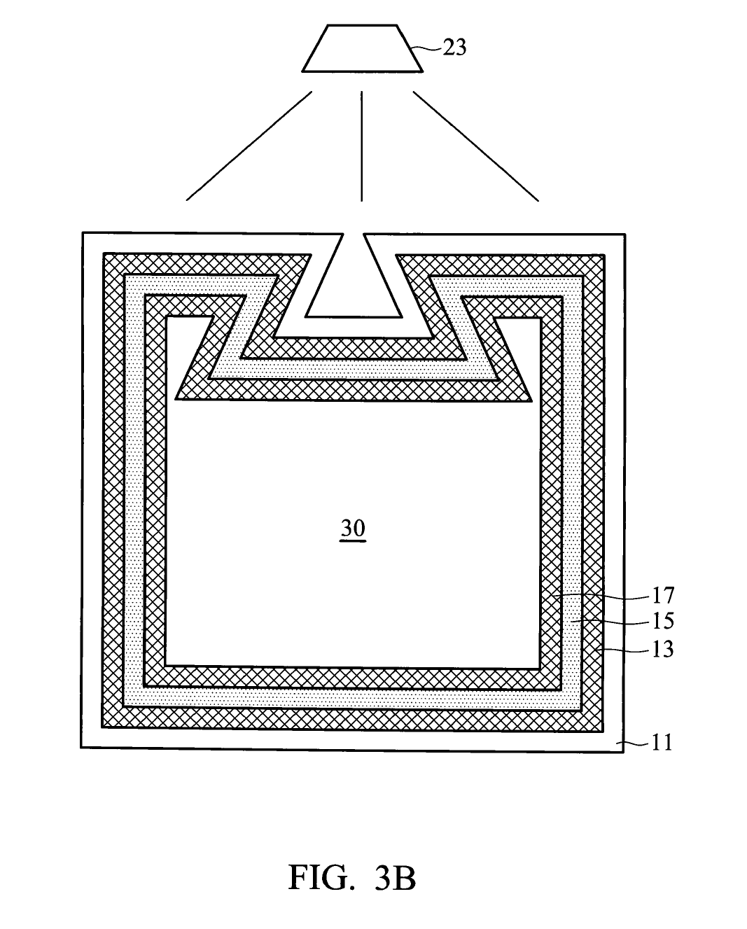

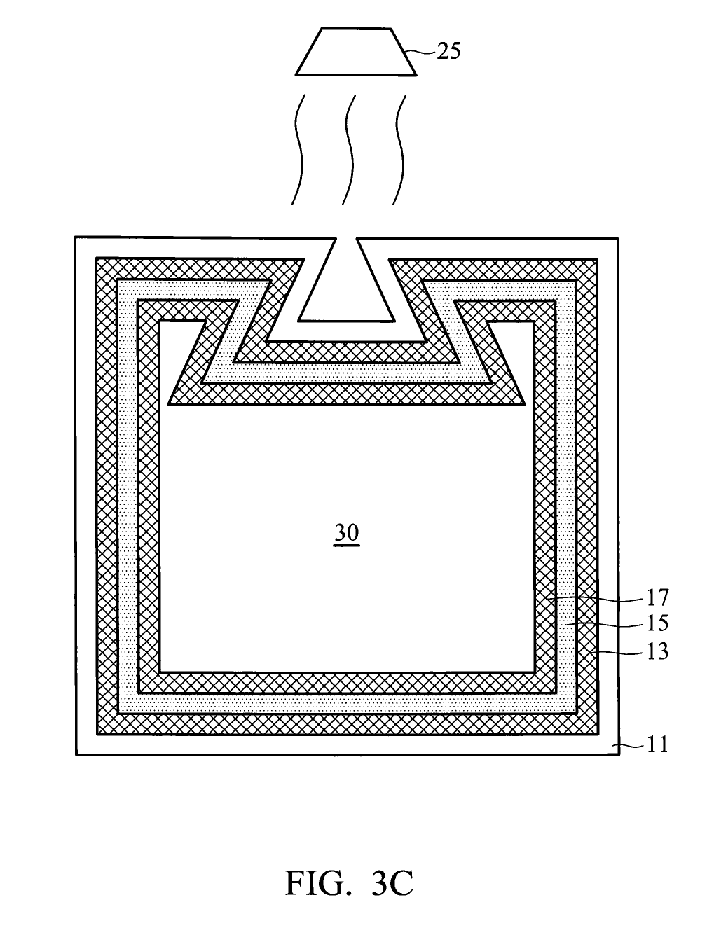

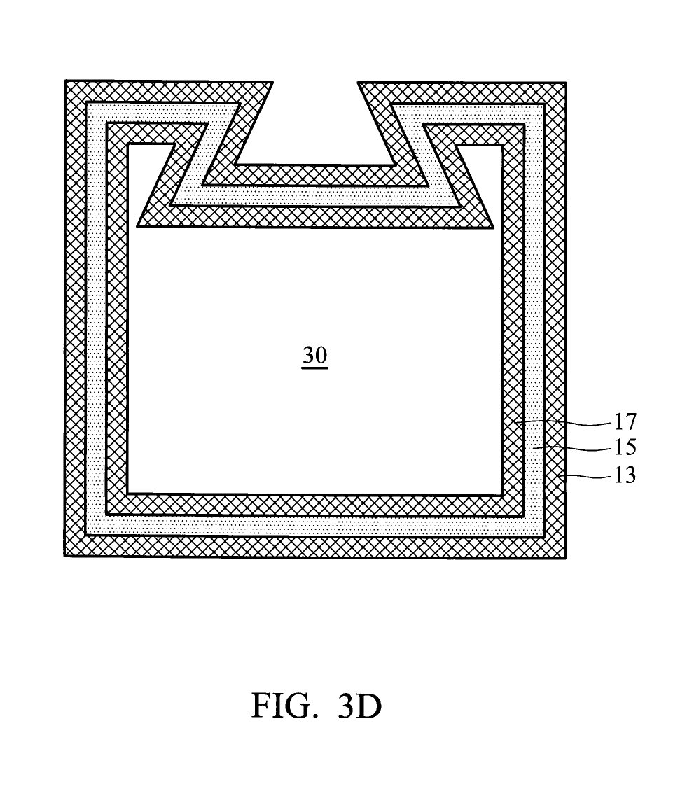

The embodiment of FIGS. 3A-3D is similar to the embodiment of FIGS. 2A-2D. The object 30 in FIGS. 3A-3D is shown as being concave to shadow a part of the protective layer 13, the ink of the decorating layer 15, and the adhesive layer 17, and the object 20 in FIGS. 2A-2D is shown as beings smooth and not concave. The processes, such as he thermal transferring and adhering in FIG. 3A, the radiation curing step in FIG. 3B, the thermal curing in FIG. 3C, and tearing the carrier layer in FIG. 3D are similar to that of FIGS. 2A-2D. Note that only the second type of post dual curing mechanism combining a radical photo initiator and a radical thermal initiator needs to perform the thermal curing step in FIG. 3C, the first type of post dual curing mechanism of combining radical photo initiator and cationic photo initiator does not needs that thermal curing step.

Compared to conventional thermal transfer-printing films, the invention utilizes post dual curing composition in the protective layer 13, the ink of the decorating layer 15, and the adhesive layer 17 has advantages as below. The conventional thermal transfer-printing needs longer thermal period and higher temperature, it will damage low thermal resistance material such as plastic. Otherwise, most part of the film including the post dual curing composition of the invention can be cured in few seconds, thereby dramatically reducing the thermal transferring/adhering temperature and period. Furthermore, the adhesive layer 17, the decorating layer 15, and the protective layer 13 have similar curing mechanism; it will form single layered material after curing. Therefore, the problems such as delaminating and peeling due to different curing mechanism and different composition of the multi-layered thermal transfer-printing film in related art can be prevented.

### EXAMPLES

### Example 1

45 parts by weight of a resin (Chimei PN117), 20 parts by weight of a resin (Johnson® J678), 18 parts by weight of an oligomer (Eternal® 6161-100), 11.5 parts by weight of an oligomer (Agisyn® 1010), 2 parts by weight of a monomer (trihydroxy methyl propane triacrylate, hereinafter TMPTA), 1 parts by weight of a monomer (1,6-hexanediol diacrylate, hereinafter HDDA), 0.5 parts by weight of a leveling agent (BYK® 354), 1 parts by weight of a radical photo initiator (Darocur® 1173), and 1 parts by weight of a radical thermal initiator (Lupersol® 231) were dissolved in solvent to form a mixture solution having a solid content of 40 wt %. The mixture solution was coated on a PVA film to form a coating having a thickness of 7-15 μm. The coating was baked and dried at 50° C. to complete a protective film.

10 parts by weight of a resin (Chimei PN107), 10 parts by weight of an oligomer (Satomers® CN704), 30 parts by weight of ink (VA08UV commercially available from HSIN MEI KUANG CO., LTD., Taiwan), 1 parts by weight of a radical photo initiator (Darocur® 1173), and 1 parts by weight of a radical thermal initiator (Lupersol® 231) were evenly mixed, and then printed on the protective layer to form a pattern thereon for completing the decorating layer.

50 parts by weight of a hot melt adhesive (780A (EVA) commercially available from Tex Year, Taiwan), 10 parts by weight of an oligomer (Satomers® CN704), 30 parts by weight of a monomer (HDDA), 4 parts by weight of a monomer (methyl methacrylate, hereinafter MMA), 4 parts by weight of a monomer (TMPTA), 1 parts by weight of a radical photo initiator (Darocur®1173), and 1 parts by weight of a radical thermal initiator (Lupersol®231) were evenly mixed, and then coated on the decorating layer to form the adhesive layer having thickness of 2 μm.

The described thermal transfer-printing film was cut into a 50 cm*50 cm sheet, vacuum adhered on the surface of an ABS curved object, and charged in an oven at 50° C. for 30 seconds. After adherence, the film was exposed to an ultraviolet light of 20 to 100 mJ/cm². The carrier layer was torn, and the initially cured protective layer had properties as follows: a cross hatch test of 100/100, a surface brightness of 92, and a thickness of 10 to 20 μm. The protective layer covering the curved object (not shadowed part) had a pencil hardness of 2H to 3H, and the protective layer under the curved part of the curved object (shadowed part) had a pencil hardness of 1H to 2H.

### Example 2

Example 2 was similar to Example 1, however, the difference in Example 2 was that another thermal curing step was processed before tearing the PVA carrier layer. The ultraviolet cured sample of Example 1 was further charged in oven at 70° C. for 25 minutes. As such, the cured film had uniform pencil hardness of 3H, in the shadowed part or not shadowed part. When comparing Examples 1 and 2, the initial radiation cured most of the thermal transfer-printing film, and the shadowed part of the film is thermally cured to obtain a similar effect.

### Example 3

Example 3 was similar to Example 1, however, the difference in Example 3 was that the radical thermal initiator was replaced by a cationic photo initiator having Iodonium (4-methylphenyl) [4-(2-methylpropyl)phenyl-hexafluorophosephate(1), (Ciba Specialty I-250). The described thermal transfer-printing film was cut to a 50 cm*50 cm sheet, vacuum adhered on the surface of an ABS curved object, and charged in an oven at 50° C. for 30 seconds. After adherence, the film was exposed to an ultraviolet light of 20 to 100 mJ/cm² for 5 minutes. The carrier layer was tom, and the cured protective layer had properties as follows: a cross hatch test of 100/100, a surface brightness of 90, and a thickness of 10 to 20 μm. The protective layer covering the curved object (not shadowed part) had a pencil hardness of 3H to 3H, and the protective layer under the curved part of the curved object (shadowed part) also had a pencil hardness of 3H. The process differences between Examples 1 and 2 was that the cationic photo initiator was easily influenced when stored or processed, and the ultraviolet exposure needed a longer period to confirm initiation of the cationic photo initiator. Furthermore, the thermal deformation factors should be considered for low thermal resistance materials. The additional thermal curing was not required in this example.

### Example 4

Example 4 was similar to Example 2, however, the difference in Example 4 was that the decorating layer was replaced by a surface relief hologram of evaporated aluminum. The decorating layer had thickness of 4 to 10 micrometers. The other steps such as the adhering step, radiation curing, thermal curing, and removing the carrier layer were similar to Example 2. The thermal transfer-printing film on the curved object had properties as follows: a cross hatch test of 100/100, a surface brightness of 90, and a thickness of 12 μm. The protective layer covering the curved object (not shadowed part) had a pencil hardness of 3H to 3H, and the protective layer under the curved part of the curved object (shadowed part) also had a pencil hardness of 3H. The decorating layer of this example is both a printing ink pattern and a surface relief hologram of evaporated metal.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A thermal transfer-printing film, comprising:
a carrier layer;
a protective layer overlying the carrier layer;
a decorating layer overlying the protective layer; and
an adhesive layer overlying the decorating layer,
wherein the protective layer and the adhesive layer are a post dual-curable composition comprising an oligomer, a monomer, a resin, and an initiator combination;
wherein the initiator combination is a combination of a radical photo initiator and a cationic photo initiator, or a combination of a radical photo initiator and a radical thermal initiator.

2. The thermal transfer-printing film as claimed in claim 1, wherein the protective layer and/or the adhesive layer are water-based or solvent-based.

3. The thermal transfer-printing film as claimed in claim 1, wherein the decorating layer comprises a printing ink pattern, metal layer, or combinations thereof.

4. The thermal transfer-printing film as claimed in claim 3, wherein the printing ink pattern is a post-curable solvent-based ink or post-curable water-based ink.

5. A thermal transfer-printing method, comprising:
transferring the thermal transfer-printing film as claimed in claim 1 on an object surface;
thermal adhering the adhesive layer to the object surface; and
radiation curing the adhesive layer and the protective layer.

6. The method as claimed in claim 5, further comprising a step of removing the carrier layer after the radiation curing step.

7. The method as claimed in claim 5, wherein the object comprises metal, ceramic, alloy, glass, wood, or plastic.

8. The method as claimed in claim 5, wherein the radiation curing step comprises an ultraviolet light, electron beam, or combinations thereof.

9. The method as claimed in claim 5, further comprising a thermal curing step to cure the adhesive layer and the protective layer.

10. The method as claimed in claim 5, wherein the decorating layer comprises a printing ink pattern, and the printing ink pattern is a post-curable solvent-based ink or post-curable water-based ink.

11. The method as claimed in claim 10, wherein the radiation curing step further cures the printing ink pattern.

12. The method as claimed in claim 10, further comprising a thermal curing step to cure the adhesive layer, the printing ink pattern, and the protective layer.
